(19) United States
(12) Patent Application Publication
(10) Pub. No.: US 2022/0090605 A1
(43) Pub. Date: Mar. 24, 2022

(54) FLUTTER-RESISTANT BLADE

(71) Applicant: ROLLS-ROYCE plc, London (GB)

(72) Inventor: Bharat M. LAD, Nottingham (GB)

(73) Assignee: ROLLS-ROYCE plc, London (GB)

(21) Appl. No.: 17/464,041

(22) Filed: Sep. 1, 2021

(30) Foreign Application Priority Data
Sep. 18, 2020 (GB) 2014745.0

(51) Int. Cl. F04D 29/38; F02C 3/00

(52) U.S. Cl. CPC F04D 29/384; F05D 2220/323; F02C 3/00

(57) ABSTRACT

An aircraft engine having a compressor, the compressor having at least one flutter-resistant blade, the blade having a leading edge (LE), a trailing edge (TE), a midchord (MC), a minimum radial height r_{hub}, a maximum radial height rₜᵢₚ, and a radial extent between r_{hub} and rₜᵢₚ, wherein, at every point along the radial extent of the blade, the blade has a modeshape value V₁ for a blade first vibratory mode defined as

$${V}_{1} = \frac{\vert {D}_{1 LE} \vert}{\vert {D}_{1 MC} \vert} ,$$

and wherein, when the engine is operating between its maximum speed and 70% of that maximum speed, at least 80% of the radial extent of the blade has a modeshape value V₁ from 0 to 1.5.

### CROSS-REFERENCE TO RELATED APPLICATIONS

This specification is based upon and claims the benefit of priority from UK Patent Application Number GB2014745.0 filed on 18 Sep. 2020, the entire contents of which are incorporated herein by reference.

### BACKGROUND

### Technical Field

The present disclosure concerns an aircraft engine having a flutter-resistant blade. The blade may be used, for example, in the compressor of the aircraft engine.

### Description of the Related Art

It is important for aircraft engines to be as mechanically reliable as possible. Aircraft engines use large fans to push large volumes of air in one direction, in order to propel the aircraft in the opposite direction. In aircraft engines powered by gas turbines, turbines and compressors are used to compress the air and extract energy from it to power the engine and rotate the main fan. The compressors comprise a circular disc or tube with an array of blades arranged around its periphery. The compressor assembly may be integrally formed during manufacturing, or formed in separate pieces and assembled separately. Every blade, or disk, when considered in isolation, possesses natural modes of vibration. A vibratory mode is a mode of vibration characterized by a modal frequency and a modeshape. The vibratory mode is, in more general terms, an eigensolution of the vibration equation of motion for a body.

During operation, the compressor blades are placed under enormous stresses owing to the aerodynamic loading and fast rotation speeds of the compressor. As a result, the compressor blades may undergo various combinations of bending and twisting motions, and under certain operating conditions, exhibit a response from a vibratory mode. The blades are designed to withstand such motions up to a point, beyond which there is a risk of the blade fracturing or breaking. One such motion is known as “utter”, where the blades of the compressor undergo self-induced vibration. Flutter can lead to the blade becoming damaged if left unchecked.

It is therefore desirable to provide an aircraft engine having a blade that minimises the risk of flutter occurring during operation of the engine.

### SUMMARY

For the purposes of the present disclosure, we are interested in the range of engine speeds between the engine mechanical redline speed, i.e. the maximum speed at which the engine and its components are designed to operate without incurring damage to themselves or other parts of the engine, and 70% of that speed.

According to a first aspect there is provided an aircraft engine having a compressor, the compressor comprising a plurality of blades, each blade having a leading edge (LE), a trailing edge (TE), a midchord (MC), a minimum radial height r_{hub}, a maximum radial height rₜᵢₚ, and a radial extent between r_{hub} and rₜᵢₚ, wherein, for a first set of blades within the plurality of blades, at every point along the radial extent of the blade, the blade has a modeshape value V₁ for a first blade vibratory mode defined as:

$${V}_{1} = \frac{\vert {D}_{1 LE} \vert}{\vert {D}_{1 MC} \vert}$$

wherein, when the engine is operating between its maximum speed and 70% of that maximum speed, at least 80% of the radial extent of the first set of blades has a modeshape value V₁ from 0 to 1.5.

An aircraft engine having a compressor comprising one or more blades with this property has been found to be more reliable, as the blade is much less susceptible to undergoing flutter.

The aircraft engine can have a compressor with a first set of blades comprising a single blade, 50% or more of the plurality of blades, 75% or more of the plurality of blades, or 90% or more of the plurality of blades.

The engine can have a compressor with one or more blades having a modeshape value V₁ from 0 to 1.0, or from 0 to 0.5, or from 0 to 0.2. The modeshape value V₁ can apply to at least 85% of the radial extent of each blade, to at least 90% of the radial extent of each blade, to at least 95% of the radial extent of each blade, or to at least 99% of the radial extent of each blade.

According to an aspect, there is provided an aircraft comprising an aircraft engine as described and/or claimed herein. The aircraft according to this aspect is the aircraft for which the engine has been designed to be attached.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only by the first core shaft, and not the second core shaft, in the example above). Alternatively, the gearbox may be arranged to be driven by any one or more shafts, for example the first and/or second shafts in the example above.

The gearbox may be a reduction gearbox (in that the output to the fan is a lower rotational rate than the input from the core shaft). Any type of gearbox may be used. For example, the gearbox may be a “planetary” or “star” gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, or 3.2 to 3.8, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. Purely by way of example, the gearbox may be a “star” gearbox having a ratio in the range of from 3.1 or 3.2 to 3.8. In some arrangements, the gear ratio may be outside these ranges.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other. The present disclosure relates to the rotor blades of the or each compressor.

Gas turbine engines in accordance with the present disclosure may have any desired bypass ratio, where the bypass ratio is defined as the ratio of the mass flow rate of the flow through the bypass duct to the mass flow rate of the flow through the engine core at cruise conditions. In some arrangements the bypass ratio may be greater than (or on the order of) any of the following: 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5 or 20. The bypass ratio may be in an inclusive range bounded by any two of the values in the previous sentence (i.e. the values may form upper or lower bounds), for example in the range of form 12 to 16, 13 to 15, or 13 to 14. The bypass duct may be substantially annular. The bypass duct may be radially outside the engine core. The radially outer surface of the bypass duct may be defined by a nacelle and/or a fan case.

In the context of this disclosure, a set of blades can equal any number of blades, from a single blade up to 100% (i.e. all) of the blades on the compressor.

### DESCRIPTION OF THE DRAWINGS

Embodiments will now be described by way of example only, with reference to the Figures, in which:

FIG. 1 is a sectional side view of a gas turbine engine;

FIG. 2 is a sectional side view of a compressor blade region of an aircraft engine;

FIG. 3 is sectional plan view of a compressor blade undergoing oscillation;

FIG. 4 is a frontal view of a compressor from a gas turbine engine; and

FIG. 5 is a schematic plan view of an aircraft with an engine according to the present disclosure.

### DETAILED DESCRIPTION

Aspects and embodiments of the present disclosure will now be discussed with reference to the accompanying figures. Further aspects and embodiments will be apparent to those skilled in the art.

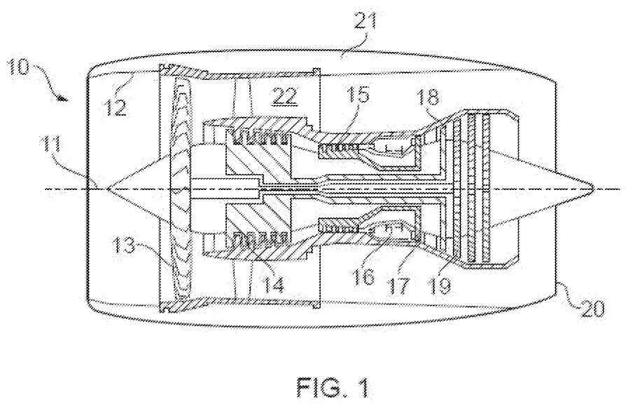

With reference to FIG. 1, an example engine, in this case a gas turbine engine, is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The disclosure herein can be applied equally to either of the intermediate or high pressure compressors described, or indeed any compressor of such a gas turbine engine. The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the exhaust nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other engines, such as other types of gas turbine engines to which the present disclosure may be applied, may have alternative configurations. For example, such engines may have an alternative number of compressors and/or turbines and/or an alternative number of interconnecting shafts. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may comprise a gearbox provided in the drive train from a turbine to a compressor and/or fan.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

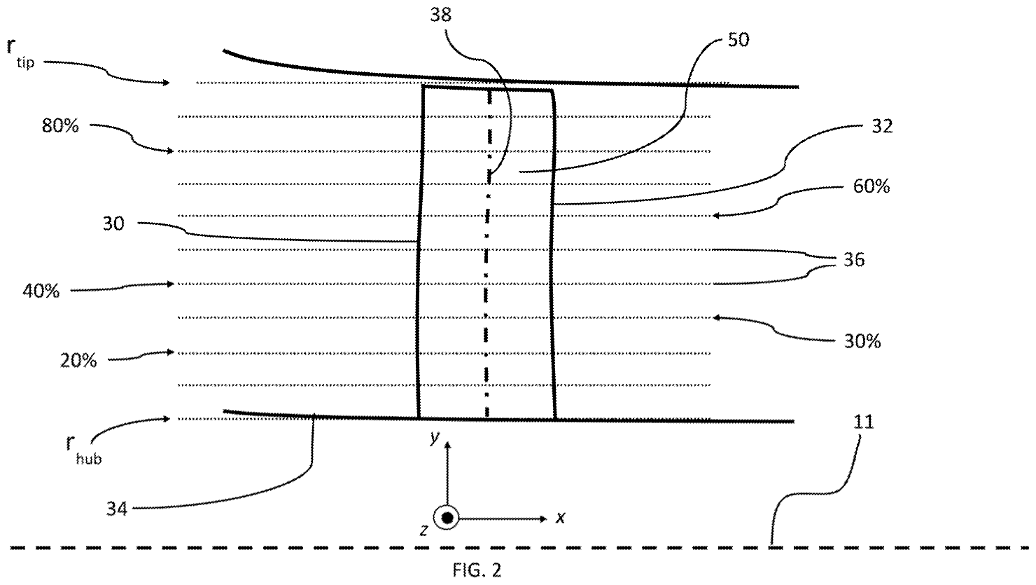

The compressors 14, 15 comprise a number of compressor blades 50, a schematic version of which is shown in FIG. 2. The forwardmost edge of each blade, i.e. the edge of the blade that during operation, air entering the compressor region of the engine arrives at first, is known as the leading edge (LE) 30 of the blade. The rearmost edge of each blade, i.e. the edge of the blade that during operation, air entering the compressor region of the engine arrives at last, is known as the trailing edge (TE) 32 of the blade. The compressor blade 50 has a radial extent (i.e. an extent in the y-axis for the co-ordinate system and blade position of FIG. 2) equal to the distance from its minimum radial height at r_{hub} to its tip at rₜᵢₚ at the top of its leading edge LE. The minimum radial height of the blade r_{hub}, equal to 0% of the blade's radial extent, is a line parallel to the principal and rotational axis 11 of the engine 10, on which lies the point of intersection of the leading edge LE 30 of the blade 50 with the radially inner wall 34 defining the inside of the flow passage for the compressor air stream. The maximum radial height of the blade rₜᵢₚ, equal to 100% of the blade's radial extent, is a line parallel to the principal and rotational axis 11 of the engine 10 on which lies the point where the leading edge 30 of the blade 50 is radially furthest from the principal and rotational axis 11 of the engine 10. A radial band is a plane that bisects the blade 50 from the leading edge LE 30 to the trailing edge TE 32 at a single radial height, i.e. a locus of points at the same percentage of the blade's radial extent running parallel to the principal axis 11 of the engine 10. In FIG. 2 radial bands 36 have been marked at 10% intervals (dotted lines) along the blade's radial extent, with the planes at 20%, 30%, 40%, 60% and 80% labelled for illustration purposes. It will be appreciated that a radial band can extend across the blade at any percentage of the blade's radial extent, and not just at those illustrated in FIG. 2. Each radial band 36 will pass through the midchord MC 38 axially halfway between the leading edge LE 30 and trailing edge TE 32 of the blade.

During operation, interaction between the compressor blades 50, the air flowing into the compressor, and the structures surrounding the compressor blades will lead to the compressor blade undergoing various modes of vibration. The compressor blade 50 will have multiple vibratory modes, and each one may exhibit different modal deflections (modeshapes). At any given radial band 36, each modeshape will exhibit a combination of harmonically oscillating axial, circumferential, and radial deflections from the zero-amplitude blade shape, which will vary across the leading edge LE 30, midchord MC 38, and trailing edge TE 32 points.

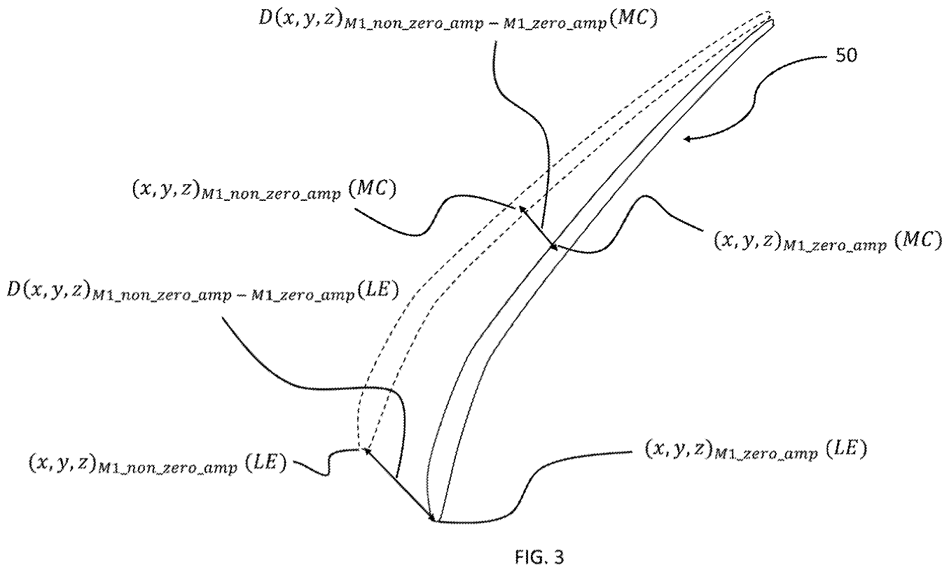

FIG. 3 shows a profile cross-section of a compressor blade 50, where the blade is undergoing oscillation during operation (i.e. rotation of the compressor). The solid cross-section represents the position of the cross-section when the amplitude of the oscillation equals zero. That is to say, the position of the cross-section when the blade 50 is undergoing oscillation, but is passing through the zero-amplitude position of the oscillation waveform. The dashed line cross-section represents the position of the cross-section when the amplitude of the oscillation is non-zero. As will become apparent, for the purposes of calculating the blade's modeshape value, the specific non-zero value of the oscillation is not important, as it is the ratio of the zero amplitude and non-zero amplitude measurements of two positions on the blade that determines the modeshape value.

Indicated in FIG. 3 are two pairs of x, y and z coordinates in the blade 50. The first pair is shown on the blade at the amplitude equals zero point of oscillation. One point of the pair, (x,y,z)_{M1_zero_amp}(MC) is at the blade's midchord (MC) 38 and the other point of the pair (x,y,z)_{M1_zero_amp}(LE) is at the blade's leading edge (LE) 30. The second pair are shown on the blade at the amplitude equals non-zero point of oscillation. One point (x,y,z)_{M1_non_zero_amp}(MC) is at the blade's midchord (MC) 38 and the other point (x,y,z)_{M1_non_zero_amp}(LE) is at the blade's leading edge (LE) 30. It is important to understand that the two points shown on the oscillation amplitude=non-zero blade are the same two points as those shown on the oscillation amplitude=zero blade; the different location is due solely to the movements of the blade 50. The measurement of the deflection, D, between the pairs of locations is also indicated. The defections at the leading edge LE and midchord MC are simply calculated by subtracting the x, y and z coordinate values at the zero amplitude position from the x, y and z coordinates in the non-zero amplitude position.

For example, for a given point on the blade, in the first mode of vibration, the deflection in the x-axis. Dx_{M1}, is equal to:

Dx_{M1}=x_{M1_non_zero_amp}−x_{M1_zero_amp}

where x_{M1_non_zero_amp} is the x-coordinate of a point on the blade when the blade is at a non-zero amplitude whilst vibrating in its 1^{st} vibratory mode, and x_{M1_zero_amp} is the x-coordinate of the same point on the blade when the blade is at zero amplitude whilst vibrating in its 1^{st} vibratory mode. Similar calculations are performed for the x, y and z coordinates for the leading edge LE and midchord position MC to calculate the modeshape value V_{α} at a given radial height of the blade. The non-zero amplitude can be at any non-zero point in the mode's oscillation; the key thing is the ratio between the amplitude of the deflections taken at the leading edge and midchord at that non-zero point. If the ratio of amplitudes is too great, it indicates the blade is more likely to undergo flutter.

The blade's modeshape value V_{α} is the measure of the relative deflection between the LE and MC points for a given blade vibratory mode α at a given operating condition (see below), and is calculated by the following formula:

$${V}_{α} = \frac{\sqrt{{Dx}_{α LE}^{2} + {Dy}_{α LE}^{2} + {Dz}_{α LE}^{2}}}{\sqrt{{Dx}_{α MC}^{2} + {Dy}_{α MC}^{2} + {Dz}_{α MC}^{2}}} = \frac{\vert {D}_{α LE} \vert}{\vert {D}_{α MC} \vert}$$

where D=the deflection. i.e. the deflected distance in the x, y and z axis at the leading edge LE (for the numerator) and midchord position MC (for the denominator) of a compressor blade in its α vibratory mode at a set operating condition. In other words, D is the comparison between the positions of the same points on the leading edge and midchord of the blade at a non-zero amplitude of vibration for a given mode, versus their positions at the zero amplitude position for that same mode. V_{α} is the ratio of the magnitude of the displacement vectors at the leading edge LE and midchord MC of the blade during its α-mode vibration.

Every vibratory mode of compressor blade 50 will have a variation in deflections both axially and radially along the blade, which will define the primary, whole body motion (modeshape) of deflection, e.g. flap or twist, etc. The amplitude of these modal deflections will vary at different operating conditions. The relative deflection between the LE and MC (i.e. the modeshape value V_{α}) can be calculated for each vibratory mode at multiple radial heights, and at different operating conditions. The modeshape value V_{α} will also be affected by the operating speed of the engine, and the rotation speed of the compressor.

It has been found that minimizing the modeshape value V_{α} can provide significant improvement in flutter stability of a compressor. This is in contrast to compressors comprising previous blade designs, which have focused on minimising a rigid blade twist measured between the leading edge and trailing edge of the blade. In particular, by reducing the modeshape value V_{∝} for the 1^{st} vibratory mode—i.e. the modeshape value V₁, which is the first mode of bending motion of the front half of the blade between the leading edge LE and midchord MC—the risk that the blade (and therefore the compressor) undergoes flutter is greatly reduced. Specifically, a compressor blade 50 operating anywhere between the engine mechanical redline speed and 70% of that speed, the deflection must be such that V₁≤1.5 for at least 80% of the radial extent of the blade to reduce the chances of the blade undergoing flutter. This condition can be expressed as follows:

$$0 \leq {V}_{1} = \frac{\sqrt{{Dx}_{1 LE}^{2} + {Dy}_{1 LE}^{2} + {Dz}_{1 LE}^{2}}}{\sqrt{{Dx}_{1 MC}^{2} + {Dy}_{1 MC}^{2} + {Dz}_{1 MC}^{2}}} = \frac{\vert {D}_{1 LE} \vert}{\vert {D}_{1 MC} \vert} \leq 1.5$$

for at least 80% of the radial extent of the blade. Avoiding flutter in turn avoids the risk of a failure of the bladeset. Avoiding flutter will also reduce stress experienced by the blade during service, increasing the lifetime of the blade.

Flutter is a phenomenon based on interaction between the blades of a compressor, and because of this, including even a single blade 50 according to the present disclosure can help reduce the chances of a compressor 14, 15 undergoing flutter. However, it will be appreciated that having more blades within the plurality of blades on a compressor will further decrease the likelihood of flutter being exhibited by the compressor during operation. For example, increasing the number of blades fulfilling the above criteria to 50% or more of the total number of blades 50 on the compressor 14, 15 will provide further protection against flutter. Indeed compressors 14, 15 may be produced with even higher percentages of such blades, such as 75% or more, or 90% or more of the blades on a compressor fulfilling the modeshape value criteria disclosed herein.

Another may to reduce the chances of a compressor 14, 15 fitted with such blades 50 from experiencing flutter during operation is to further reduce the acceptable modeshape value exhibited by the blade 50. For example, the maximum acceptable modeshape value could be reduced from 1.5 down to 1.0, 0.5, or even 0.2. Blades having even smaller modeshape values have been shown to have even smaller probabilities of undergoing flutter during operation.

Furthermore, increasing the percentage of the radial extent of the blade 50 that fulfils the modeshape value criteria disclosed herein has also been found to decrease the likelihood of the compressor 14, 15 from undergoing flutter. For example, increasing the percentage of the radial extent of the blade 50 exhibiting a modeshape value of 1.5 or less from 80% up to 85% improves the blade's, and therefore the compressor's resistance to flutter. Increasing the percentage of the radial extent of the blade 50 still further, for example to 90% or more, 95% or more or 99% or more still further reduces the likelihood of the compressor 14, 15 from undergoing flutter. The distribution of the percentage of the blade 50 fulfilling the modeshape value criteria can be varied. For example, referring to FIG. 2, 80% of the radial extent of the blade could be fulfilled by having the region from r_{hub} to the 80% radial extent line fulfil the modeshape value criteria. Alternatively, the region from the 20% radial extent line to rₜᵢₚ could fulfil the modeshape value criteria. In a further alternative, the criteria could be fulfilled over two or more regions along the span of the blade, for example between 10% and 50%, and between 55% and 95% of the radial extent of the blade. It will be apparent to the skilled person that the regions of the blade can be divided up as necessary, providing at least 80% of the radial extent of the blade fulfils the desired modeshape value criteria described above.

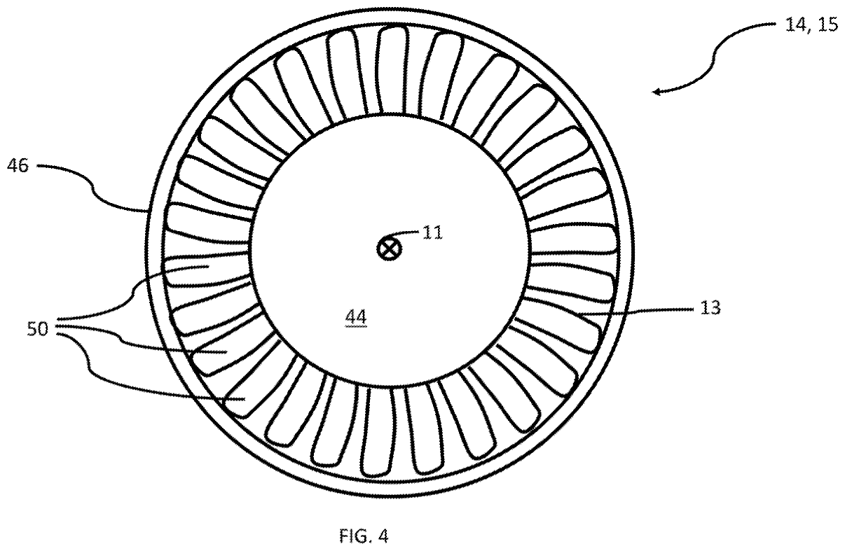

FIG. 4 shows a frontal view of a compressor 14, 15 section of an engine 10 such as that shown in FIG. 1, comprising the compressor 14, 15 surrounded by the outer boundary of the compressor 46. The compressor comprises a central hub 44, to which each of the blades 50 is mounted. In some embodiments the blades are separate entities which are attached to the hub, and in other embodiments the blades can be integral with the hub. For the purposes of the disclosure this difference is immaterial. In the example compressor of FIG. 4, there are twenty-six blades 50 on the compressor 14, 15. The phenomenon of flutter is one that effects the compressor as a whole system, and therefore the behaviour of each blade 50 can contribute to or mitigate the effect. Therefore, including even just a single blade 50 fulfilling the criteria outlined earlier can help reduce the possibility of the compressor 14, 15 undergoing flutter. However, increasing the number of blades 50 which exhibit desirable modeshape values will further reduce the possibility of the compressor 14, 15 undergoing flutter. For example, if a set of thirteen blades (i.e. 50%) in FIG. 4 had a modeshape value V₁ from 0 to 1.5 for at least 80% of the radial extent of each blade 50, the possibility of the compressor 14, 15 undergoing flutter during operation would be further reduced compared with just a single blade 50. The thirteen blades could be distributed in any way around the hub 44, for example every other blade, or grouped together on one half of the compressor 14, 15, or in groups of two or three blades with two or three other blades in-between. The skilled person will appreciate that many variations are possible, with the benefit of the present disclosure being apparent providing at least one blade 50 of the plurality of blades on the compressor 14, 15 fulfils the desired modeshape value criteria described above.

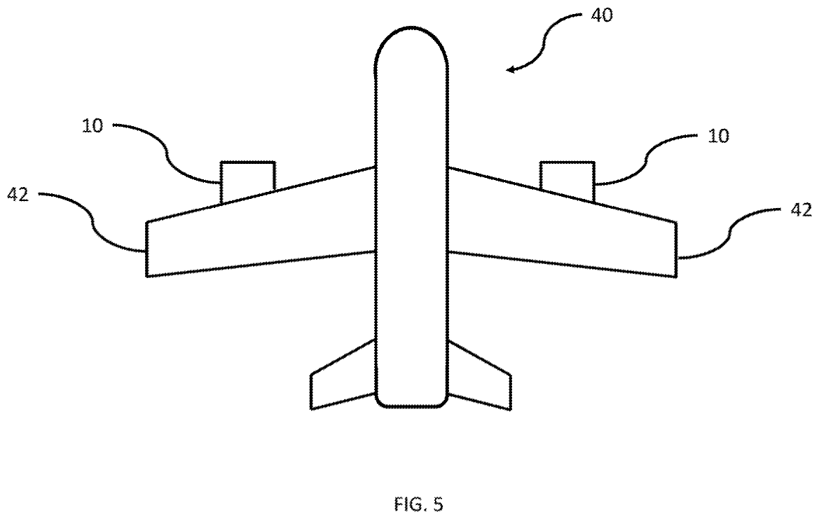

FIG. 5 shows an aircraft 40 with an engine 10 mounted under each wing 42. By using aircraft engines 10 with compressors 14, 15 such as those disclosed herein, the aircraft 40 provides improved performance over existing aircraft.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. An aircraft engine having a compressor, the compressor comprising a plurality of blades, each blade having a leading edge (LE), a trailing edge (TE), a midchord (MC), a minimum radial height r_{hub}, a maximum radial height rₜᵢₚ, and a radial extent between r_{hub} and rₜᵢₚ;
wherein, for a first set of blades within the plurality of blades, at every point along the radial extent of each blade of the first set of blades, each blade of the first set of blades has a modeshape value V₁ for a blade first vibratory mode defined as:
$${V}_{1} = \frac{\vert {D}_{1 LE} \vert}{\vert {D}_{1 MC} \vert}$$
wherein, when the engine is operating between its maximum speed and 70% of that maximum speed, at least 80% of the radial extent of each blade of the first set of blades has a modeshape value V₁ from 0 to 1.5.

2. The aircraft engine of claim 1, wherein the first set of blades consists of a single blade.

3. The aircraft engine of claim 1, wherein the first set of blades consists of 50% or more of the plurality of blades.

4. The aircraft engine of claim 1, wherein the first set of blades consists of 75% or more of the plurality of blades.

5. The aircraft engine of claim 1, wherein the first set of blades consists of 90% or more of the plurality of blades.

6. The aircraft engine of claim 1, wherein the modeshape value V₁ of each blade of the first set of blades is from 0 to 1.0.

7. The aircraft engine of claim 1, wherein the modeshape value V₁ of each blade of the first set of blades is from 0 to 0.5.

8. The aircraft engine of claim 1, wherein the modeshape value V₁ of each blade of the first set of blades is from 0 to 0.2.

9. The aircraft engine of claim 1, wherein the modeshape value V₁ applies to at least 85% of the radial extent of each of the blades in the first set of blades.

10. The aircraft engine of claim 1, wherein the modeshape value V₁ applies to at least 90% of the radial extent of each of the blades in the first set of blades.

11. The aircraft engine of claim 1, wherein the modeshape value V₁ applies to at least 95% of the radial extent of each of the blades in the first set of blades.

12. The aircraft engine of claim 1, wherein the modeshape value V₁ applies to at least 99% of the radial extent of each of the blades in the first set of blades.

13. An aircraft having at least one aircraft engine according to claim 1.
